(19) United States
(12) Patent Application Publication
(10) Pub. No.: US 2025/0110205 A1
(43) Pub. Date: Apr. 3, 2025

(54) METHOD FOR CALCULATING GATING SCORES IN PULSE-DOPPLER RADAR SYSTEMS USING A FUSION OF POSITION, POWER, DETECTION SIZE AND AMBIGUOUS DOPPLER MEASUREMENT DATA

(71) Applicant: VIETTEL GROUP, Ha Noi City (VN)

(72) Inventors: TRUNG KIEN TRAN, Ha Noi City (VN); THI THANH TRAN, Ha Noi City (VN); VAN KHUONG NGUYEN, Ha Noi City (VN); DUONG NAM PHAM, Ha Noi City (VN); VU HOP TRAN, Ha Noi City (VN)

(73) Assignee: VIETTEL GROUP, Ha Noi City (VN)

(21) Appl. No.: 18/899,690

(22) Filed: Sep. 27, 2024

(30) Foreign Application Priority Data
Oct. 3, 2023 (VN) 1-2023-06878

(51) Int. Cl. G01S 7/292; G01S 13/00; G01S 13/58

(52) U.S. Cl. CPC G01S 7/2927; G01S 13/006; G01S 13/582

(57) ABSTRACT

The invention relates to a method of calculating gating scores in the pulse-Doppler radar using a combination of position, power, size of detection and ambiguous Doppler measurement data to effectively overcome the phenomenon of wrongly assigning detections to the target trajectory and creating false targets in noise regions. The method intelligently merges position, power, detection size and ambiguous Doppler measurement data information of the detections in the algorithm of calculating gating score to solve the problem of selection and disputation detections. The method is carried out through two steps, step 1: determine statistical quantities from the standard data set; step 2: gating selection algorithm.

### TECHNICAL FIELD

The invention relates to a method of calculating gating scores in the pulse-Doppler radar. The method utilizes a combination of position, power, size of detections and Doppler measurement data to effectively overcome the phenomenon of wrongly assigning detections to the target trajectory and creating false targets in noise regions. Specifically, the proposed method intelligently merges position, power, size of detections and Doppler measurement data information of the detections in the algorithm of calculating gating score to solve the problem of selection and disputation detections.

### Technical Status

In the pulse-Doppler radar system, the reflected signals from the target are processed and digitized into the detections on the resolution cells of the azimuth-range according to the polar coordinates. These detections provide information about the position, power, detection size and Doppler value of the reflected signal. They are then forwarded to a secondary processing system (information processor) to perform the tasks of the multi-target tracker. This system has the function of combining the current detections with existing tracks to give the latest trajectory information of the targets. The initialization process has the function of creating trajectories for new detections. Gating refers to a spatial volume that encompasses new detections that are capable of pairing with the existing trajectory. The gating selection algorithm evaluates the gating score value for each detection within the target trajectory window and uses these score values of all detection-trajectory pairs to facilitate an auction, ultimately selecting the most appropriate detection-trajectory pair.

Currently, the initiation and tracking problem plays an important and core role in the radar data processing. In the process of implementing the problem, there were many difficulties and challenges, especially in the detection selection and disputation algorithm. In particular, the regular change of environment and weather, this greatly affects the process of tracking target. The traditional detections selection and disputation algorithm have a big limitation of using only position information to calculate the score value of the detections in the target window, so the system will incur phenomena such as the target will wrongly choose detection in the noise region, objects may be close to each other and the measurements received might not distinguish between these objects, many false targets were observed in the noise region.

Each detection, in addition to position information, Doppler, detection size and power information, also provides information about the target's status. However, when using a low pulse repetition frequency (PRF) in a pulse-Doppler radar system, there can be an issue with ambiguity in the Doppler frequency shift. The reason is that the Doppler frequency shift in the frequency spectrum aliases an integer number of times the pulse repetition frequency. The Doppler frequency shift ranges from −PRF/2 to +PRF/2 corresponding to M Doppler banks, where M is the number of coherent pulses. Each Doppler bank has a resolution of PRF/M (unit: Hz). The Doppler bank value of the detection is ambiguous because it is impossible to determine accurately the Doppler frequency shift of the target.

The invention provides a solution that uses flexible integration of position information, ambiguous Doppler, detection size and power in the gating score calculation algorithm to effectively overcome the phenomenon of misassigning detections to the target trajectories and the initializing false targets in the noise region. The method utilizes radial velocity information that is calculated indirectly from the range and timestamp of the detection, then it is converted to an estimated Doppler value. If this detection belongs to the target, the difference between the estimated Doppler value and Doppler measurement value will be small. This is a new and effective solution when directly applying ambiguous Doppler frequency shift information. Similarly, if a detection belongs to the target, the difference between the current detection's power value and the average power value of the target's historical rounds will also be small. Moreover, if a detection belongs to the target, the difference between the current detection's size value and the average size value of the target's historical rounds will also be small. By investigating the reliability (or error) of each position, Doppler, detection size and power measurements, an appropriate set of weights for these measurements will be calculated and apply.

### Technical Essence of the Invention

The purpose of the invention is to propose the method of calculating the gating score and assigning detection-trajectory using a combination of position, power, detection size and ambiguous Doppler frequency shift.

To achieve this purpose, the problem-solving method includes the following steps (refer to FIG. 1):

step 1: determine statistical quantities from the standard data set: collect a data set of radar targets that are paired with ground-truth data based on similarity of position, trajectory, velocity and direction of movement (heading angle); statistics quantities to be determined from the standard data set including: mean and standard deviation of the Doppler difference values, power difference values, detection size difference values; the cut threshold value for the Doppler difference distance, power difference distance, detection size difference distance and position distance;

step 2: perform the gating selection algorithm: determine the radial velocity from range and timestamp; determine the estimated Doppler from the radial velocity; determine the Doppler difference, power difference and detection size difference; determine the Doppler difference distance, power difference distance, detection size difference distance and position distance; calculate the score value for each distance value; normalize the score value; calculate the total gating sore for the detection; the total gating score value of the detection in the gate of all tracks is put into the auction algorithm to select the most appropriate track-to-detection;

### DESCRIPTION OF THE DRAWINGS

FIG. 1: diagram of the implementation steps of the method of calculating gating score and selecting detection-trajectory on the pulse-Doppler radar using a combination of position, power, detection size and ambiguous Doppler frequency shift;

FIG. 2: steps to calculate the mean and standard deviation of Doppler difference, power difference and detection size difference;

FIG. 3: steps to determine threshold values for Doppler difference distance, power difference distance, detection size difference distance and position distance;

FIG. 4: implementation steps of the gating selection algorithm; and

FIG. 5: the result of the gating score value of the detections in the target window of the traditional method and the proposed method.

### DETAILED DESCRIPTION

The invention provides the method of improving the accuracy of the multi-target tracking system on the pulse-Doppler radar using a combination of position, Doppler and power measurements in both the trajectory management and detection-trajectory correlation blocks.

The invention employs incorporating position, power, detection size and Doppler in the gating selection algorithm. The steps to implement this approach are illustrated in FIG. 1. A comprehensive breakdown of the method's procedure is outlined in the following section:

Step 1: Determine Statistical Quantities from the Standard Data Set

Collect a data set of radar targets that are paired with ground-truth data based on similarity of position, trajectory, velocity and direction of movement (heading).

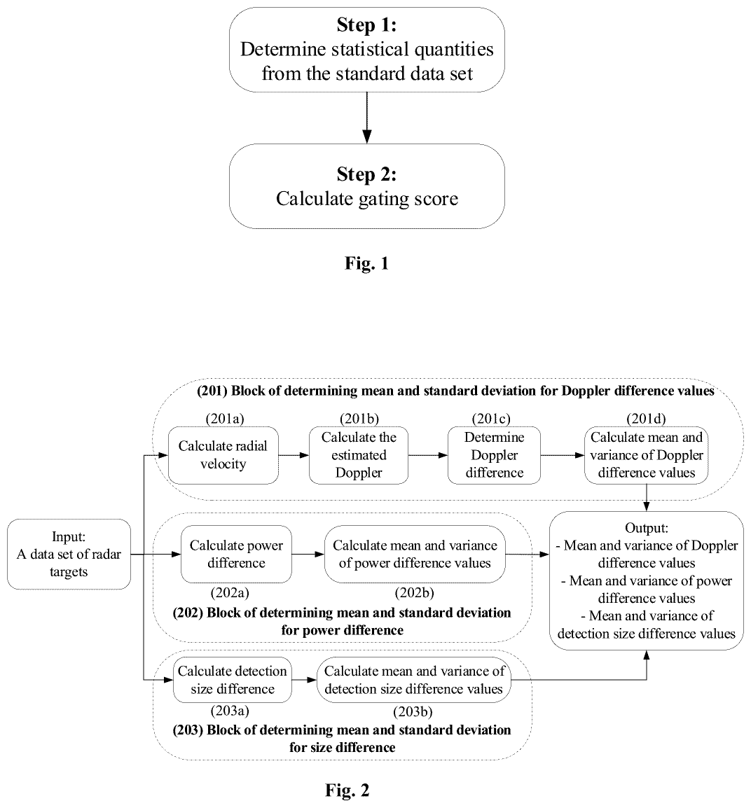

Refer to FIG. 1, statistics quantities to be determined from the standard data set include: mean and standard deviation of the Doppler difference values, power difference values, detection size difference; the cut threshold value for the Doppler difference distance, power difference distance, detection size difference distance and position distance.
Refer to FIG. 2, block (201) shows steps for determining the mean and variance for the Doppler difference values.
Calculate the radial velocity (201a):
   Determine the radial velocity using the range and timestamp of the N consecutive samples in the following formula:

$${rr}_{i} = \frac{1}{N} * ( \frac{{r}_{i - N + 1} - {r}_{i - N + 2}}{{t}_{i - N + 2} - {t}_{i - N + 1}} + \frac{{r}_{i - N + 2} - {r}_{i - N + 3}}{{t}_{i - N + 3} - {t}_{i - N + 2}} + … + \frac{{r}_{i - 1} - {r}_{i}}{{t}_{i} - {t}_{i - 1}} )$$

### Where:

rr: radial velocity, unit: m/s
r: range, unit: m
t: timestamp, unit: s
i: i^{th} sample
N is the integer selected depending on the maneuverability of the target and the radar update rate. The less maneuver the target or the faster the radar update rate, the greater N can choose. In common situations, we propose to use N in the range of 2-4.
   The timestamp is taken directly from the Analog-to-Digital module of the hardware device to increase the accuracy of calculating the value of the radial velocity.
Calculate the estimated Doppler from the radial velocity (201b):
   The estimated Doppler [symbol] is calculated from the radial velocity according to the following formula:

$$Doppler Abs = mod ( \frac{rr}{{v}_{d}} , M )$$

### Where:

DopplerAbs: the absolute estimated Doppler value
v_{d}: Doppler resolution (m/s)
M: the total number of Doppler banks processed
+ If the Doppler increases clockwise with the original bank F₀,

$$= mod ( {F}_{0} + Doppler Abs , M )$$

where:
[symbol] : the estimated Doppler
F₀: the original bank value
+ If the Doppler increases counter-clockwise with the original bank F₀,

$$= \{ \begin{matrix}{F}_{0} - Doppler Abs & if {F}_{0} \geq Doppler Abs \\ {F}_{0} + M - Doppler Abs & if {F}_{0} < Doppler Abs\end{matrix}$$

Determine Doppler difference (201c):

The main idea of using Doppler information is that assuming yⁱ is the detection of the target at the time i, the value of the estimated Doppler from the radial velocity will be approximately equal to the measured Doppler at the time i.

The Doppler difference is calculated as follows:

$$Δ {F}_{D} = \vert {F}_{D} - \vert$$

$$If$$

$$Δ {F}_{D} > M / 2 :$$

$$Δ {F}_{D} = M - Δ {F}_{D}$$

### Where:

ΔF_{D}: Doppler difference
F_{D}: the measured Doppler of the detection
   The use of the Doppler difference is completely unwavering by the Doppler ambiguity problem.
Calculate mean and variance of Doppler difference values (201d):

$${μ}_{Δ {F}_{D}} = \frac{1}{K} {\sum }_{k = 1}^{K} Δ {F}_{{D}_{k}}$$

$${S}_{Δ {F}_{D}}^{2} = \frac{1}{K} {\sum }_{k = 1}^{K} {( Δ {F}_{{D}_{k}} - {μ}_{Δ {F}_{D}} )}^{2}$$

### Where:

μ_{ΔF}_{_{D}}: mean of Doppler difference values
S_{ΔF}_{_{D}}²: variance of Doppler difference values
K: size of Doppler difference value set
   Refer to FIG. 2, block (202) shows steps for determining the mean and variance for the power difference values.

Similarly, the main idea of using power information is that assuming yⁱ is the detection of the target at the time i, the value of the measured power at the time i will be approximately equal to the mean power of the target. In particular, the power value used to calculate is the normalized value regardless of the range.
Calculate the power difference value (202a):

$$Δ P = \vert P - \overline{P} \vert$$

### Where:

ΔP: power difference
P: the measured power
P̅: the mean power
   Calculate mean and variance of power difference values (202b):

$${μ}_{Δ P} = \frac{1}{K} {\sum }_{k = 1}^{K} Δ {P}_{k}$$

$${S}_{Δ P}^{2} = \frac{1}{K} {\sum }_{k = 1}^{K} {( Δ {P}_{k} - {μ}_{Δ P} )}^{2}$$

### Where:

μ_{ΔP}: mean of power difference values
S_{ΔP}²: variance of power difference values
   Refer to FIG. 2, block (203) shows steps for determining the mean and variance for the detection size difference values.

The size of the radar detection remains consistent over time and varies with the type of object and the distance from which it is observed. In high-resolution radars, the detection size is also proportional to the size of the target being observed. The main idea of using detection size information is that assuming yⁱ is the detection of the target at the time i, the value of the detection size at the time i will be approximately equal to the mean size of the target.
Calculate the detection size difference value (202a):

$$Δ Si = \vert Si - \overline{S ι} \vert$$

### Where:

ΔSi: detection size difference
Si: the measured detection size
S̅i̅: the mean detection size
   Calculate mean and variance of detection size difference values (203b):

$${μ}_{Δ Si} = \frac{1}{K} {\sum }_{k = 1}^{K} Δ {Si}_{k}$$

$${S}_{Δ Si}^{2} = \frac{1}{K} {\sum }_{k = 1}^{K} {( Δ {Si}_{k} - {μ}_{Δ Si} )}^{2}$$

### Where:

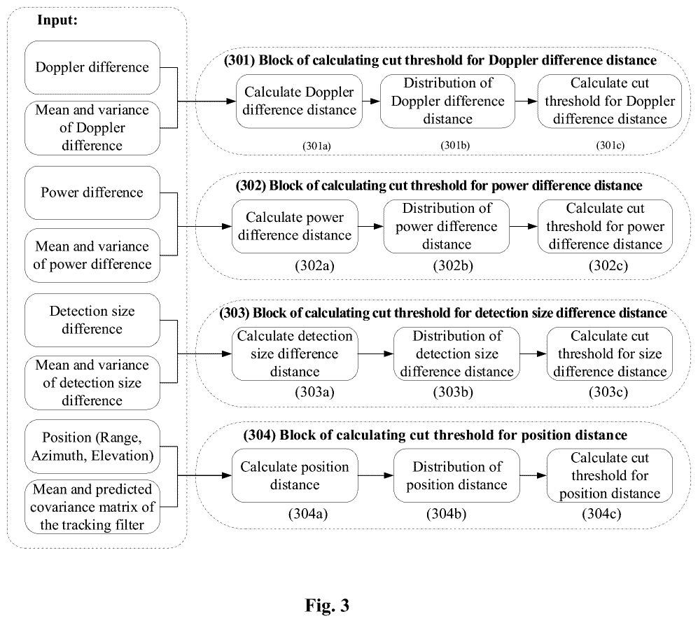

μ_{ΔSi}: mean of size difference values
S_{ΔSi}²: variance of size difference values.
   Refer to FIG. 3, block (301) shows steps of determining the cut threshold for Doppler difference distance.
   The Doppler difference distance is calculated according to the following formula (301a):

$${d}_{Δ {F}_{D}} = \sqrt{( Δ {F}_{D} - {μ}_{Δ {F}_{D}} ) {( {S}_{Δ {F}_{D}}^{2} )}^{- 1} {( Δ {F}_{D} - {μ}_{Δ {F}_{D}} )}^{- 1}}$$

Where, d_{ΔF}_{_{D}} is Doppler difference distance.
Determine distribution for the Doppler difference distance values (301b):
   Assuming the set of Doppler difference distance values follows a certain distribution P, it is necessary to test the statistical hypothesis:
H₀: the set of Doppler difference distance values follows the P distribution
H₁: the set of Doppler difference distance values does not follow the P distribution
   Using Chi-square goodness-of-fit test with 5% significance level, if p-value is greater than 5%, the hypothesis H₀ cannot be rejected, it means the set of Doppler difference distance values follows the P distribution.
The cut threshold of the Doppler difference distance (301c) is determined by:

$${thres}_{{F}_{D}} = {F}^{- 1} ( 95 \% )$$

Where F is the cumulative distribution function of Doppler difference distance distribution.
Refer to FIG. 3, block (302) shows steps of determining the cut threshold for power difference distance.
The power difference distance (302a) is calculated according to the following formula:

$${d}_{Δ P} = \sqrt{( Δ P - {μ}_{Δ P} ) {( {S}_{Δ P}^{2} )}^{- 1} {( Δ P - {μ}_{Δ P} )}^{- 1}}$$

The method of determining distribution (302b) and cut threshold value thres_{ΔP} (302c) for the power difference distance is done the same as the method of determining the distribution and the cut threshold for the set of Doppler difference distance values.
   Refer to FIG. 3, block (303) shows steps of determining the cut threshold for detection size difference distance.
The size difference distance (303a) is calculated according to the following formula:

$${d}_{Δ S i} = \sqrt{( Δ S i - {μ}_{Δ S i} ) {( {S}_{Δ S i}^{2} )}^{- 1} {( Δ S i - {μ}_{Δ S i} )}^{- 1}}$$

The method of determining distribution (303b) and cut threshold value thres_{ΔSi} (303c) for the size difference distance is done the same as the method of determining the distribution and the cut threshold for the set of Doppler difference distance values.
   Refer to FIG. 3, block (304) shows steps of determining the cut threshold for position distance.
Position distance dₚ (304a) is determined by:

$${d}_{p} = \sqrt{( p - {μ}_{p} ) {{Σ}^{- 1} ( p - {μ}_{p} )}^{- 1}}$$

### Where:

p: position vector (including x, y, z coordinates converted from range, azimuth and elevation)
μₚ: predicted position vector of the tracking filter
Σ: predicted covariance matrix of the tracking filter
   The method of determining distribution (304b) and cut threshold value thresₚ (304c) for the position distance is done the same as the method of determining the distribution and the cut threshold for the set of Doppler difference distance values.

### Step 2: The Gating Selection Algorithm

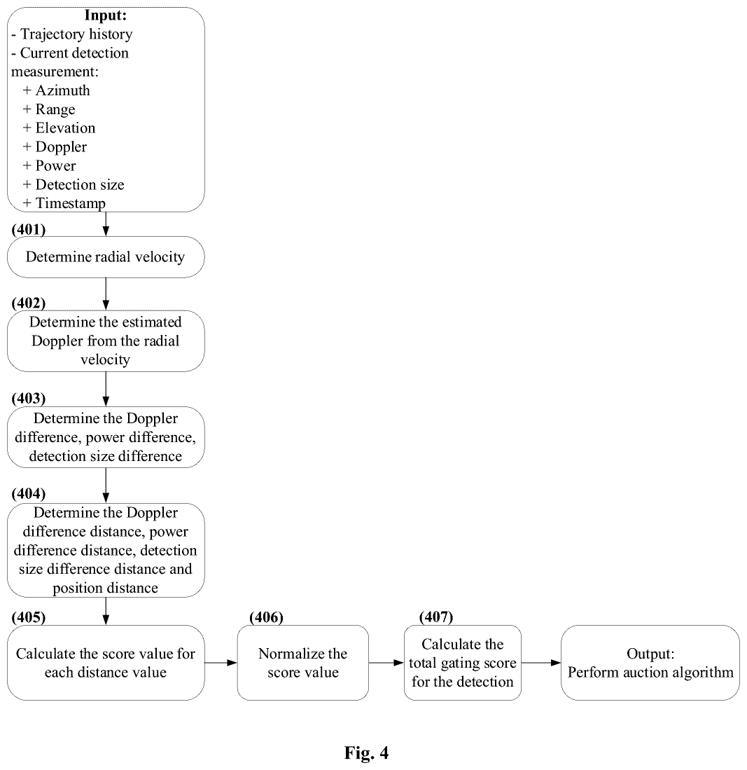

Refer to FIG. 4, the gating selection algorithm is carried out sequentially through the following steps:
Determine the radial velocity (401):
   The method for determining the radial velocity value has been presented in step 1.
Determine the estimated Doppler from the radial velocity (402):
   The method for determining the estimated Doppler has been presented in step 1.
Determine the Doppler difference, power difference and detection size difference (403):
   The method for determining the Doppler difference, power difference and detection size difference have been presented in step 1.
Determine the Doppler difference distance, power difference distance, detection size difference distance and position distance (404):
   The method for determining the Doppler difference distance, power difference distance, detection size difference distance and position distance have been presented in step 1.
Calculate the score value for each distance value (405)
+ The score value for the Doppler difference distance score_{ΔF}_{_{D}} is calculated using the following form:

$${score}_{Δ {F}_{D}} = \{ \begin{matrix}( {thres}_{{F}_{D}} - {d}_{Δ {F}_{D}} ) & if {d}_{Δ {F}_{D}} < {thres}_{{F}_{D}} \\ 0 & if {d}_{Δ {F}_{D}} > {thres}_{{F}_{D}}\end{matrix}$$

+ The score value for the power difference distance score_{ΔP} is calculated according to the following formula:

$${score}_{Δ P} = \{ \begin{matrix}( {thres}_{Δ P} - {d}_{Δ P} ) & if {d}_{Δ P} < {thres}_{Δ P} \\ 0 & if {d}_{Δ P} > {thres}_{Δ P}\end{matrix}$$

+ The score value for the size difference distance score_{ΔSi} is calculated according to the following formula:

$${score}_{Δ S i} = \{ \begin{matrix}( {thres}_{Δ Si} - {d}_{Δ Si} ) & if {d}_{Δ Si} < {thres}_{Δ Si} \\ 0 & if {d}_{Δ Si} > {thres}_{Δ Si}\end{matrix}$$

+ The score value for the position distance score, can be derived as:

$${score}_{p} = \{ \begin{matrix}( {thres}_{p} - {d}_{p} ) & if {d}_{p} < {thres}_{p} \\ 0 & if {d}_{p} > {thres}_{p}\end{matrix}$$

Normalize the score value (406)

Because Doppler, detection size and power are used to complement the position information to enhance the efficiency of the detection score calculation function, the score values must be normalized in the range of [0-q]:

$${score}_{Δ {F}_{{D}_{n o r m}}} = \frac{{score}_{Δ {F}_{D}} * q}{{thres}_{{F}_{D}}}$$

$$scor {e}_{Δ {P}_{n o r m}} = \frac{{score}_{Δ P} * q}{{thres}_{Δ P}}$$

$$scor {e}_{Δ S {i}_{n o r m}} = \frac{{score}_{Δ S i} * q}{{thres}_{Δ S i}}$$

Where q=qₘₐₓ/3 and qₘₐₓ is the maximum value of the position distance scores.
Calculate the total sore for the detection (407)

The total score value TScore of the detection in the target gate shows the appropriate level of that detection for the target. The higher the value of this TScore value, the more suitable the detection to assign the target.

$$TScore = {score}_{p} + {w}_{D o p p l e r} * s c o r {e}_{Δ {F}_{{D}_{n o r m}}} + {w}_{P o w e r} * s c o r {e}_{Δ {P}_{n o r m}}$$

$$Where {w}_{D o p p l e r} and {w}_{P o w e r} are weights of {score}_{Δ {F}_{{D}_{n o r m}}} and {score}_{Δ {P}_{n o r m}} , repectively .$$

$${w}_{Doppler} + {w}_{P o w e r} = 1$$

The value of the weights depends on the measurement accuracy of each quantity in the radar system.
The auction algorithm:

The total score value of the detection in the gate of all tracks is put into the auction algorithm to select the most appropriate track-to-detection.

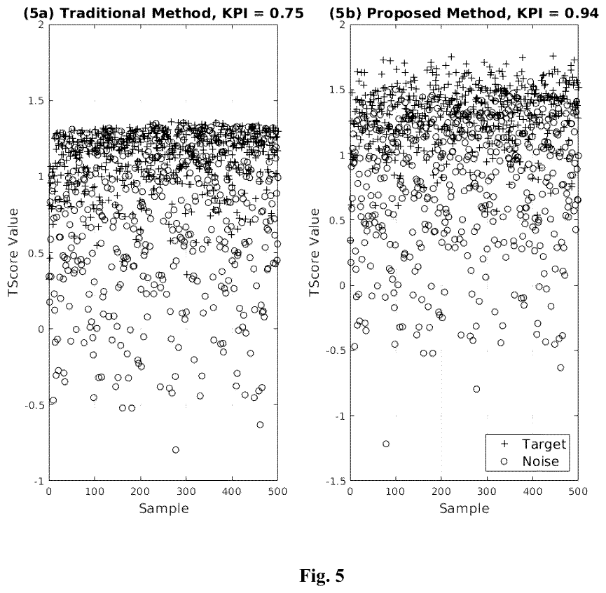

FIG. 5 shows the total score values of detections in the target gate for the traditional method (using only position) and the proposed method, the parameters and weights used are as follows, w_{Doppler}=⅓, w_{Power}=⅓, w_{Size}=⅓, q=0.45. The integrated use of position, power, detection size and ambiguous Doppler frequency shift in the gate selection algorithm gives better results than using only position information. The total score values of detections from targets are more clearly separated from those of noise. The Key Performance Indicator (KPI) of the proposed method is 25% higher than that of the traditional method. The KPI comparison quantity, determining the ratio of target detections with higher total score values than noise detections to the total number of samples considered, is calculated accordingly:

$$KPI = \frac{\begin{matrix}the number of samples with target detection total \\ score values > noise detection total score values\end{matrix}}{the total number of samples} ( \% )$$

1. A method of calculating a gating score and assigning detection-trajectory on pulse-Doppler radar using a combination of position, power, detection size and ambiguous Doppler frequency shift includes 2 steps:
step 1: determine statistical quantities from a standard data set; step 1: determine statistical quantities from the standard data set: collect a data set of radar targets that are paired with ground-truth data based on similarity of position, trajectory, velocity and direction of movement (heading angle); statistics quantities to be determined from the standard data set include: mean and standard deviation of the Doppler difference values, power difference values, detection size difference values; a cut threshold value for the Doppler difference distance, power difference distance, detection size difference distance and position distance;
step 2: perform a gating selection algorithm: determine a radial velocity from a range and a timestamp; determine an estimated Doppler value from the radial velocity; determine a Doppler difference, power difference and detection size difference; determine a Doppler difference distance, power difference distance, detection size difference distance and position distance; calculate a score value for each distance value; normalize the score value; calculate a total gating sore for the detection; the total gating score value of the detection in the gate of all tracks is put into an auction algorithm to select a most appropriate track-to-detection.

2. The method of calculating a gating score and assigning detection-trajectory on pulse-Doppler radar using a combination of position, power, detection size and ambiguous Doppler frequency shift according to claim 1, in which:
calculate the radial velocity and the estimated Doppler value: determine the radial velocity using the range and timestamp of N consecutive samples in the following formula:
$${rr}_{i} = \frac{1}{N} * ( \frac{{r}_{i - N + 1} - {r}_{i - N + 2}}{{t}_{i - N + 2} - {t}_{i - N + 1}} + \frac{{r}_{i - N + 2} - {r}_{i - N + 3}}{{t}_{i - N + 3} - {t}_{i - N + 2}} + … + \frac{{r}_{i - 1} - {r}_{i}}{{t}_{i} - {t}_{i - 1}} )$$
where:
rr: radial velocity, unit: m/s
r: range, unit: m
t: timestamp, unit: s
i: sample i^{th}
N is an integer selected depending on maneuverability of the radar target and the data update cycle of the radar, the less maneuvering the target or the faster the target data update, the greater N can be chosen, in common situations, N is in the range of 2-4;
the timestamp is taken directly from an Analog-to-Digital module of a hardware device to increase accuracy of calculating the value of the radial velocity;
the estimated Doppler [symbol] is calculated from the radial velocity according to the following formula:
$$DopplerAbs = mod ( \frac{r r}{{ν}_{d}} , M )$$
if the Doppler increases clockwise with an original bank F₀,
$$= mod ( {F}_{0} + DopplerAbs , M )$$
if the Doppler increases counter-clockwise with the original bank F₀,
$$= \{ \begin{matrix}{F}_{0} - DopplerA bs & n {\hat{e}}^{′} u {F}_{0} \geq DopplerA bs \\ {F}_{0} + M - DopplerA bs & n {\hat{e}}^{′} u {F}_{0} < DopplerA bs\end{matrix} .$$

3. The method of calculating the gating score and assigning detection-trajectory on pulse-Doppler radar using a combination of position, power, detection size and ambiguous Doppler frequency shift according to claim 1, in which: utilizing Doppler difference values, power difference values and detection size difference values in the gating selection algorithm; using Doppler, power and detection size information is that assuming yⁱ is the detection of the target at the time i, the value of the estimated Doppler from the radial velocity will be approximately equal to the measured Doppler at the time i; similarly, the value of the measured power at the time i will be approximately equal to the mean power of the target, the power value used to calculate is a normalized value regardless of the range; the value of the detection size at the time i will be approximately equal to a mean size value of the target's historical rounds;
determine Doppler difference:
$$Δ {F}_{D} = \vert {F}_{D} - \vert$$
$$if Δ {F}_{D} > N / 2 :$$
$$Δ {F}_{D} = N - Δ {F}_{D}$$
the use of the Doppler difference is completely unwavering by the Doppler ambiguity problem;
calculate the power difference:
$$Δ P = \vert P - \overline{P} \vert$$
calculate the detection size difference:
$$Δ Si = \vert Si - \overline{{S}_{l}} \vert .$$

4. The method of calculating the gating score and assigning detection-trajectory on pulse-Doppler radar using a combination of position, power, detection size and ambiguous Doppler frequency shift according to claim 1, in which: calculate Doppler difference distance, power difference distance, detection size difference distance, position distance, specifically:
Doppler difference distance from a point ΔF_{D} to a distribution of Doppler difference values is calculated according to the following formula:
$${d}_{Δ {F}_{D}} = \sqrt{( Δ {F}_{D} - {μ}_{Δ {F}_{D}} ) {( {S}_{Δ {F}_{D}}^{2} )}^{- 1} {( Δ {F}_{D} - {μ}_{Δ {F}_{D}} )}^{- 1}}$$
power difference distance:
$${d}_{Δ P} = \sqrt{( Δ P - {μ}_{Δ P} ) {( {S}_{Δ P}^{2} )}^{- 1} {( Δ P - {μ}_{Δ P} )}^{- 1}}$$
detection size difference distance:
$${d}_{Δ S i} = \sqrt{( Δ S i - {μ}_{Δ S i} ) {( {S}_{Δ S i}^{2} )}^{- 1} {( Δ S i - {μ}_{Δ S i} )}^{- 1}}$$
position distance:
$${d}_{p} = \sqrt{( p - {μ}_{p} ) {{Σ}^{- 1} ( p - {μ}_{p} )}^{- 1}} .$$

5. The method of calculating the gating score and assigning detection-trajectory on pulse-Doppler radar using a combination of position, power, detection size and ambiguous Doppler frequency shift according to claim 1, in which: the method of calculating the score value of each detection in the gating is carried out sequentially through 7 steps: step 1, determine the radial velocity; step 2, determine the estimated Doppler from the radial velocity; step 3, determine the Doppler difference, power difference, detection size difference; step 4, determine the Doppler difference distance, power difference distance, detection size difference distance and position distance; step 5, calculate the score value for each distance value in step 4; step 6, normalize the score value in step 5; step 7, calculate the total sore for the detection; perform auction algorithm.

6. The method of calculating the gating score and assigning detection-trajectory on pulse-Doppler radar using a combination of position, power, detection size and ambiguous Doppler frequency shift according to claim 1, in which:
calculate score value for the Doppler difference distance:
$${score}_{Δ {F}_{D}} = \{ \begin{matrix}{thres}_{{F}_{D}} - {d}_{Δ {F}_{D}} & if {d}_{Δ {F}_{D}} < {thres}_{{F}_{D}} \\ 0 & if {d}_{Δ {F}_{D}} > {thres}_{{F}_{D}}\end{matrix}$$
the cut threshold of the Doppler difference distance thres_{F}_{_{D}} is determined by:
$${thres}_{{F}_{D}} = {F}^{- 1} ( 95 \% )$$
where F is a cumulative distribution function of Doppler difference distance distribution
calculate score value for power difference distance:
$${score}_{Δ P} = \{ \begin{matrix}{thres}_{Δ P} - {d}_{Δ P} & if {d}_{Δ P} < {thres}_{Δ P} \\ 0 & if {d}_{Δ P} > {thres}_{Δ P}\end{matrix}$$
the cut threshold of the power difference distance thres_{ΔP} is determined so that covers 95% of the values of the power difference distance distribution;
calculate score value for the detection size difference distance:
$${score}_{Δ Si} = \{ \begin{matrix}{thres}_{Δ Si} - {d}_{Δ Si} & if {d}_{Δ Si} < {thres}_{Δ Si} \\ 0 & if {d}_{Δ Si} > {thres}_{Δ Si}\end{matrix}$$
the cut threshold of the detection size difference distance thres_{ΔSi} is determined so that covers 95% of the values of the size difference distance distribution;
calculate score value for the position distance:
$${score}_{p} = \{ \begin{matrix}{thres}_{p} - {d}_{p} & if {d}_{p} < {thres}_{p} \\ 0 & if {d}_{p} > {thres}_{p}\end{matrix} .$$

7. The method of calculating the gating score and assigning detection-trajectory on pulse-Doppler radar using a combination of position, power, detection size and ambiguous Doppler frequency shift according to claim 1, in which: Method of normalizing the score value, Doppler, power and detection size are used to complement the position information to enhance the efficiency of the detection score calculation function, so the score values must be normalized in the range of [0-q]:
$${score}_{Δ {F}_{{D}_{norm}}} = \frac{{score}_{Δ {F}_{D}} * q}{{thres}_{{F}_{D}}}$$
$$scor {e}_{Δ {P}_{norm}} = \frac{{score}_{Δ P} * q}{{thres}_{Δ P}}$$
$$scor {e}_{Δ S {i}_{norm}} = \frac{{score}_{Δ S i} * q}{{thres}_{Δ S i}}$$
where q=qₘₐₓ/3 and qₘₐₓ is the maximum value of the position distance scores.

8. The method of calculating the gating score and assigning detection-trajectory on pulse-Doppler radar using a combination of position, power, detection size and ambiguous Doppler frequency shift according to claim 1, in which:
determine the total score value of each detection in the target trajectory gate using the combination of 4 score values of the Doppler difference distance, the power difference distance, detection size difference distance and the position distance, the weights of score_{ΔF}_{_{Dnorm}}, score_{ΔP}_{ₙₒᵣₘ} and score_{ΔSi}_{ₙₒᵣₘ} are chosen depending on the measurement accuracy of each quantity in the radar system;
$$Score = {score}_{p} + {w}_{Doppler} * {score}_{Δ {F}_{{D}_{norm}}} + {w}_{Power} * {score}_{Δ {P}_{norm}}$$
$$where {w}_{Doppler} , {w}_{P o w e r} and {w}_{S i z e} are weights of {score}_{Δ {F}_{{D}_{norm}}} , {score}_{Δ {P}_{norm}} and {score}_{Δ S {i}_{n o r m}} , respectively ;$$
$${w}_{Doppler} + {w}_{Power} + {w}_{S i z e} = 1$$
the value of the weights depends on the measurement accuracy of each quantity Doppler, power and detection size in the radar system, the higher the value of this score, the more suitable the detection to assign the target trajectory.
